(19) United States
(12) Patent Application Publication
(10) Pub. No.: US 2014/0006004 A1
(43) Pub. Date: Jan. 2, 2014

(54) GENERATING LOCALIZED USER INTERFACES

(71) Applicant: MICROSOFT CORPORATION, (unknown)

(72) Inventors: Mahender Gundepuneni, Redmond, WA (US); Agustin Da Fieno Delucchi, Bellevue, WA (US); Anders Riis Hansen, Frederiksberg C. (DK); Daniel Goldschmidt, Herlev (DK); Toshio Shimoaraiso, Kirkland, WA (US)

(73) Assignee: Microsoft Corporation

(21) Appl. No.: 13/645,516

(22) Filed: Oct. 5, 2012

Related U.S. Application Data
(60) Provisional application No. 61/667,045, filed on Jul. 2, 2012.

(51) Int. Cl. G06F 17/28

(52) U.S. Cl. 704/2

(57) ABSTRACT

Adaptation rules are prepared and applied against a parent language string in order to adapt the parent language string to a parent language variant. Previous adaptation translations are first used and then un-adapted translation units are matched against the adaptation rules that are applied to adapt the translation units. To design or text a user interface, a set of translation candidates is obtained for a source language string and one of the translation candidates is selected based on its size. The area of the selected translation candidate is calculated and a pseudo-localized string is generated based on the calculated area for the selected translation candidate. The pseudo-localized string is then used in generating or testing user interface displays.

The present application is based on and claims the benefit of U.S. provisional patent application Ser. No. 61/667,045, filed Jul. 2, 2012, the content of which is hereby incorporated by reference in its entirety.

### BACKGROUND

There are currently many computer programs and systems that are offered in multiple different geographic regions around the world. This often means that text in the computer software and related documentation must be translated into a number of different languages. For instance, the support documentation for computer programs, as well as the resource files and other user interface text strings, are often translated into a variety of different languages, when the corresponding product is offered for sale in countries that use those different languages.

The problems associated with translating (or localizing) text strings used in computer programs, and related documentation, into a variety of different languages, is exacerbated because some languages have multiple different variants. By way of example, assume that a product is being sold in countries that speak a parent language, such as German. In order to accurately meet the specific linguistic needs of such countries, products offered in those countries often need to be translated into language variants (called adaptations) of the corresponding parent language. For instance, the German language is somewhat different in Austria than it is in Germany. While it is true that both countries speak the parent language (German) they each have their own variant of that parent language, such as German-Germany and German-Austria.

Translating text strings corresponding to a product into variants of a parent language has often been done manually. That is, a manual translator uses the parent language content and manually adapts it to accommodate changes used in the adapted language (or the parent language variant).

Another problem associated with translating (or localizing) a computer product for use in a target language has to do with designing user interface displays used with the computer program. For instance, when a developer develops a product in a source language, the developer designs the user interface displays so that text in the source language can be adequately displayed, without being truncated and without being otherwise displayed in an awkward fashion. However, when the source language text is translated to a target language, or a target language variant, the size of the text may be longer or larger (depending on the font used in the target language) or shorter or smaller than the source language text. Therefore, when the product is translated or localized, the text strings in the target language (or target language variant) may be truncated or displayed awkwardly.

In order to address this problem, some current developers use a practice known as pseudo-localization in building and testing software for international adequacy. The pseudo-localization process replaces the characters in a given source string (such as in an English language string) with characters from a target set (such as Unicode) and changes the size of the string by adding extra characters to it. For instance, when one current pseudo-localization process is run on a product where the source language is the English language, the process uses a fixed formula for adding characters to resource strings in the source language. One specific example generates a pseudo-localized target character set that uses 140 percent of the character count found in the English language source string. That is, the fixed formula for pseudo-localization assumes that no translations (or localizations) will be larger than 140 percent of the number of characters found in the source string. However, this fixed formula approach does not accurately represent the dynamic and diverse size of the world's written languages.

One example of where the fixed formula pseudo-localization approach does not work is when translating from the English language to a language such as Greek. The word “e-mail”, with the fixed-formula localization approach applied to it, would be expanded by 140 percent. That is, the six-character long string “e-mail” (which is 33 pixels long in “Tahoma” 8 pt. font) would be expanded to a maximum length of seventeen characters long (110 pixels long in “Tahoma” 8 pt. font). This is calculated as follows:

33 pixels×140%+a beginning delimiter width of 50 pixels+an ending delimiter width of 15 pixels).

Thus, the pseudo-localized string would be 110 pixels long. However, this does not provide an accurate pseudo-localization string when translating to a number of different languages. For instance, the word “e-mail” translated to Greek is a 35 character-long string (which is 192 pixels long in “Tahoma” 8 pt. font).

The discussion above is merely provided for general background information and is not intended to be used as an aid in determining the scope of the claimed subject matter.

### SUMMARY

Adaptation rules are prepared and applied against a parent language string in order to adapt the parent language string to a parent language variant. Previous adaptation translations are first used and then un-adapted translation units are matched against the adaptation rules that are applied to adapt the translation units.

To design or test a user interface, a set of translation candidates is obtained for a source language string and one of the translation candidates is selected based on its size. The area of the selected translation candidate is calculated and a pseudo-localized string is generated based on the calculated area for the selected translation candidate. The pseudo-localized string is then used in generating or testing user interface displays.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of a business adaptation system.

FIG. 2 is a flow diagram illustrating the overall operation of the system shown in FIG. 1.

FIG. 3 is a flow diagram illustrating how adaptation rules are generated.

FIG. 3A is one illustrative user interface display.

FIGS. 4A and 4B show a flow diagram illustrating execution of a rules-based adaptation translation process.

FIG. 5 is a flow diagram illustrating one embodiment of recycling already-existing adaptation translations.

FIG. 6 is a flow diagram illustrating one embodiment of reviewing translation units.

FIG. 6A is one illustrative user interface display.

FIG. 7 is a flow diagram illustrating one illustrative embodiment of rule validation.

FIG. 8 shows a block diagram of one embodiment of a user interface generation/test system.

FIGS. 9A and 9B show a flow diagram illustrating one embodiment of the overall operation of the system shown in FIG. 8.

FIG. 10 shows one illustrative user interface display.

FIG. 11 shows a block diagram of various architectures that can be employed.

FIGS. 12-16 show various embodiments of mobile devices.

FIG. 17 is a block diagram of one illustrative computing environment.

### DETAILED DESCRIPTION

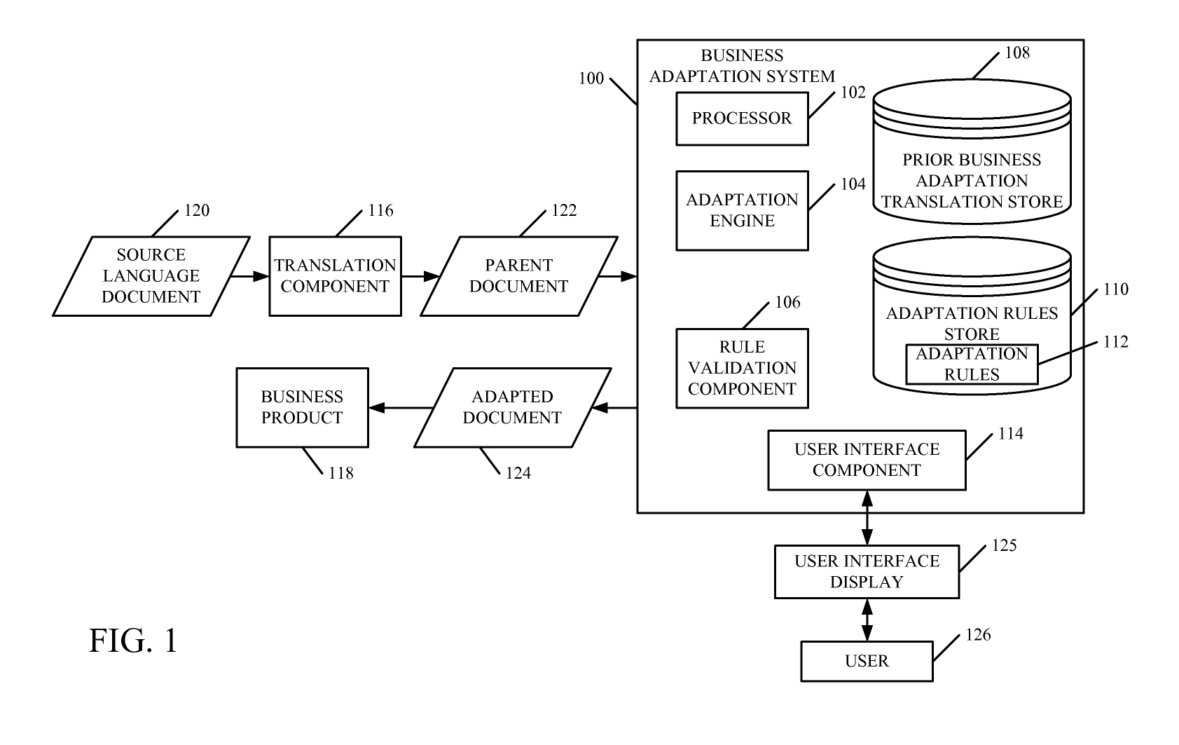

FIG. 1 is a block diagram of business adaptation system 100. System 100 includes processor 102, adaptation engine 104, rules validation component 106, prior business adaptation translation store 108, adaptation rules store 110 (that includes adaption rules 112) and user interface component 114. In the embodiment shown in FIG. 1, system 100 is shown coupled to translation component 116, and business product 118.

Processor 102 illustratively includes a computer processor with associated memory and timing circuitry (not shown). Processor 102 illustratively forms a functional part of system 100 and is activated by, and facilitates the functionality of, other components and engines in system 100.

Data stores 108 and 110 are shown within system 100. Of course, they could be remote from system 100 or in a different architecture as well. Similarly, each data store 108 and 110 could be multiple data stores, or the data stores could be combined into a single data store. All of these architectures are contemplated herein.

Various embodiments of the operation of system 100 are described below with respect to the other figures. Briefly, however, for the sake of overview, system 100 is used for adapting a document in a parent language to a language variant. For instance, if the parent language is German, system 100 adapts the document in German, to the particular variant of German that is spoken in Austria. In any case, a source language document 120 is translated by a translation component 116 to a document in the parent language. The parent document is indicated by block 122. Adaptation engine 104 applies adaptation rules 112 in data store 110, and also uses prior adaption translations from store 108 to adapt translation units in parent document 122 so that parent document 122 is adapted to the particular language variant. Rule validation component 106 validates that the rules have been applied correctly and system 100 outputs the adapted document 124 for inclusion in a business product 118.

User interface component 114 illustratively generates user interface displays 125 that display information for user 126. User interface displays 125 also illustratively include user input mechanisms for receiving inputs from user 126 so that user 126 can interact with the various parts of system 100. User 126 may do this to generate adaption rules 112, to review an adapted document, or for other reasons. In one embodiment, the user input mechanisms can receive user inputs from a point and click device (such as a mouse), from a hardware keyboard, a virtual keyboard, voice inputs, keypads, or other inputs. In addition, where user interface 125 is displayed on a touch sensitive screen, the user inputs can be touch gestures that user 126 inputs using a finger, a stylus, or another input mechanism.

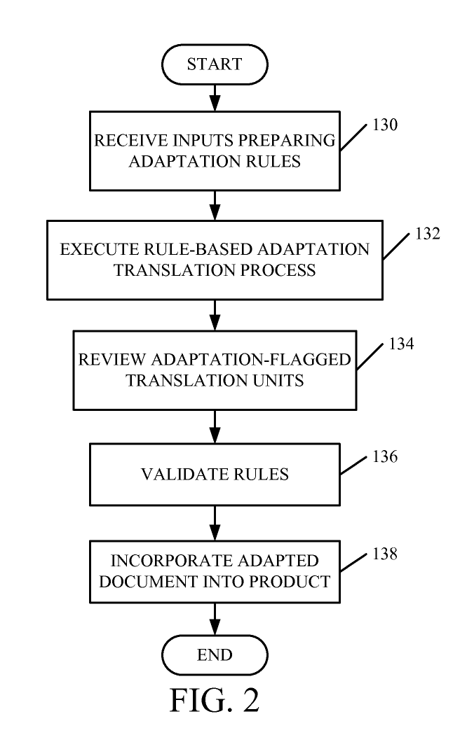

FIG. 2 is a flow diagram showing one embodiment of the overall operation of system 100 shown in FIG. 1 in more detail. System 100 first receives inputs from user 126 through a suitable user interface display 125 that prepares or modifies adaptation rules 112, and stores them in adaption rules store 110. This is indicated by block 130 in FIG. 2. Adaption engine 104 then receives parent document 122 and executes a rules-based adaption translation process on parent document 122 to adapt parent document 122 so that it reflects a variant language. Executing the rule-based adaptation translation process is indicated by block 132 in FIG. 2.

In applying the process, adaption engine 104 illustratively marks certain translation units (or flags them) for further review. Therefore, the document with flagged translation units is displayed, by user interface component 114, for review by user 126. Reviewing the adaptation-flagged translation units is indicated by block 134 in FIG. 2. In reviewing those translation units, user 126 either corrects them or approves them and changes the associated flag, accordingly.

Rules validation component 106 then validates that the adaptation rules 112 have been correctly applied to the parent document. For instance, rule validation component 106 validates that rule exclusions and rule scope have been followed. Validating the rules is indicated by block 136 in FIG. 2. Finally, the adapted document 124 is output and incorporated into business product 118. This is indicated by block 138 in FIG. 2.

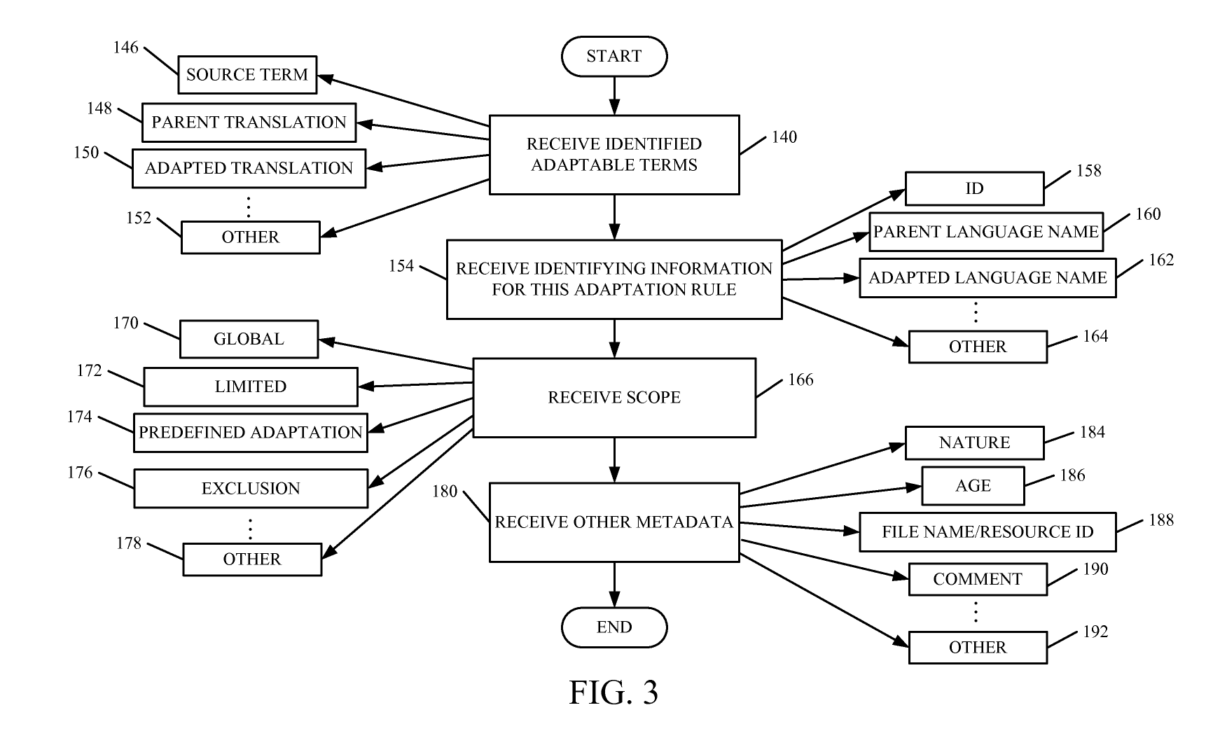

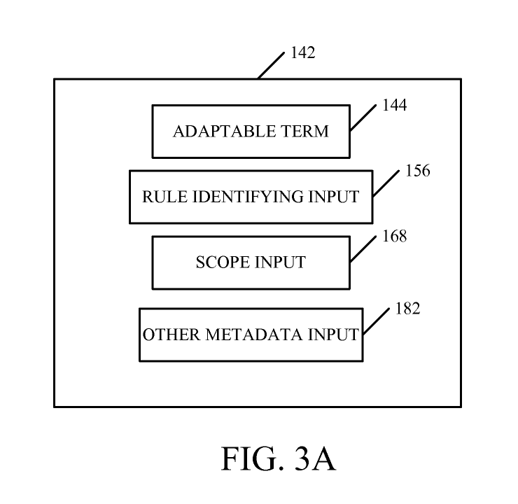

FIGS. 3 and 3A illustrate the preparation of adaption rules 112 in more detail. In one embodiment, user interface component 114 generates a suitable user interface display 125 for receiving inputs from user 126 in order to generate adaptation rules 112. As an initial process, a translator may analyze source language document 120 and parent language document 122 to identify source strings and corresponding parent translations that may have adaptable terms. This can be done by an automated process or manually. In one embodiment, it is a continuing process that is performed intermittently, during a project translation cycle. In any case, the translator illustratively has linguistic knowledge about the parent language and differences between the parent language and adapted languages.

Once a possibly adaptable term is identified, it is received by system 100 and displayed to user 126. This is indicated by block 140 in FIG. 3. FIG. 3A shows one illustrative user interface display 142 that displays the adaptable term 144 to user 126. In one embodiment, the adaptable term 144 that is displayed to user 126 includes source term 146, parent translation 148, adapted translation 150, and any other desired information 152. User 126 may then decide that an adaptation rule 112 needs to be generated for this particular adaptable term.

System 100 then receives, again through an illustrative user interface display, identifying information for this adaptation rule, from user 126. Receiving the identification information is indicated by block 154 in FIG. 3. In the embodiment shown in FIG. 3A, user interface display 142 receives the identifying input through a suitable user input mechanism 156. The identifying information can include, by way of example, a rule identifier 158, a parent language name 160, an adapted language name 162 and other information 164. By way of example, the parent language name might be “German” while the adapted language name might be “German-Austria”. Of course, these are given by way of example only.

Once the adaptation rule has been identified, system 100 can receive from user 126 (again through a suitable user interface display) a rule scope that is to be assigned to this adaptation rule. Receiving the rule scope is indicated by block 166 in FIG. 3, and FIG. 3A shows that a suitable user input mechanism 168 can be used to receive the scope input on user interface display 142.

User 126 can decide that the scope of the adaptation rule should be applied globally, for each instance of the adaptable term. Global scope means that the adaption rule is applied to all translation units in a given translation container (e.g., in a given resource file, error message, etc). A translation unit is a low level entity of a translatable sentence, illustratively in a resource file. The translation unit contains the source term to be translated, a translation and metadata about the resource (such as the resource identifier, translation locks where translations are not to be made, various translation flags that detect the translation status, the origin and scope of the translation, and additional customized information). Global scope is indicated by block 170 in FIG. 3.

User 126 can assign other scopes to the present adaptation rule as well. For example, a limited scope may mean that the adaptation rule is applied to a subset of translation units in the given translation container based on a condition. A file level condition, for instance, can be a file name or regular expression for selecting multiple resource files, and the adaptation rule can be applied to that file or to multiple resource files. A resource level condition can be used to select one or more of a group of translation units based on resource ID ranges, expressions, translation unit flags, or other resource level conditions. Limited scope is indicated by block 172 in FIG. 3.

User 126 can also illustratively assign a predefined adaptation scope. In that case, the adaptation rule is defined to override both global and limited scopes. This may be done for specific targeted words or selected translation units, by uniquely identifying them with the help of the file name and resource ID. Predefined adaptation scope is indicated by block 174 in FIG. 3.

The user 126 may assign the scope by defining exclusions where the adaptation rule is excluded, or not applied. An exclusion defines an expressed translation unit that is excluded from the adaptation process. Of course, an exclusion can also be used to define a group of translation units or other areas that are excluded from the process based on resource ID ranges, translation unit flags, etc. Assigning exclusions as part of the scope is indicated by block 176 in FIG. 3.

Of course, user 126 can provide other or different scopes as well. This is indicated by block 178 in FIG. 3.

Once the user 126 has assigned a scope to the present adaptation rule, the user can also illustratively provide other metadata as indicated by block 180 in FIG. 3. FIG. 3A shows that user interface display 142 allows the user 126 to input other metadata through a suitable user interface mechanism 182. In one embodiment, the other metadata includes the nature of the adapted term under consideration. The nature may include the culture, the legal significance of the term, language reform information or domain specific information related to the particular adaptable term. The nature of the term is indicated by block 184 in FIG. 3. The user can also input the adaptation rule age so that later users can decide whether the rule is a new rule, an old rule, or a relatively old rule, etc. This is indicated by block 186. The user may also include the file name or resource ID that the adaptable term belongs to and this is indicated by block 188. The user 126 can also provide other comments as indicated by block 190. Of course, this type of metadata is illustrative only and other metadata 192 can be input as well.

In any case, once the user has generated an adaptation rule, it may illustratively include the information set out in Table 1 below.

TABLE 1

| | |
|---|---|
| Adaptation ID | unique identification for adaptation rule |
| Parent language name | parent language information (can be |
| | LCID, culture name), etc. |
| Adapted language name | adapted language information (can be LCID, |
| | culture name), etc. |
| Source term | source term (English) for which adaptation is |
| | carried out |
| Parent translation | parent language translation for source term |
| Adapted translation | Adapted language translation for source term |
| Adaptation scope | explained above |
| Adaptation nature | nature of the adapted term, such as Culture, |
| | Legal, Language reform, Domain specific |
| Adaptation rule age | to decide whether given rule is new or old. |
| | Based on this, adaptation execution scope can |
| | be decided |
| Filename, resource id | is useful for some adaptation scopes |
| Comments | for general level of comments |

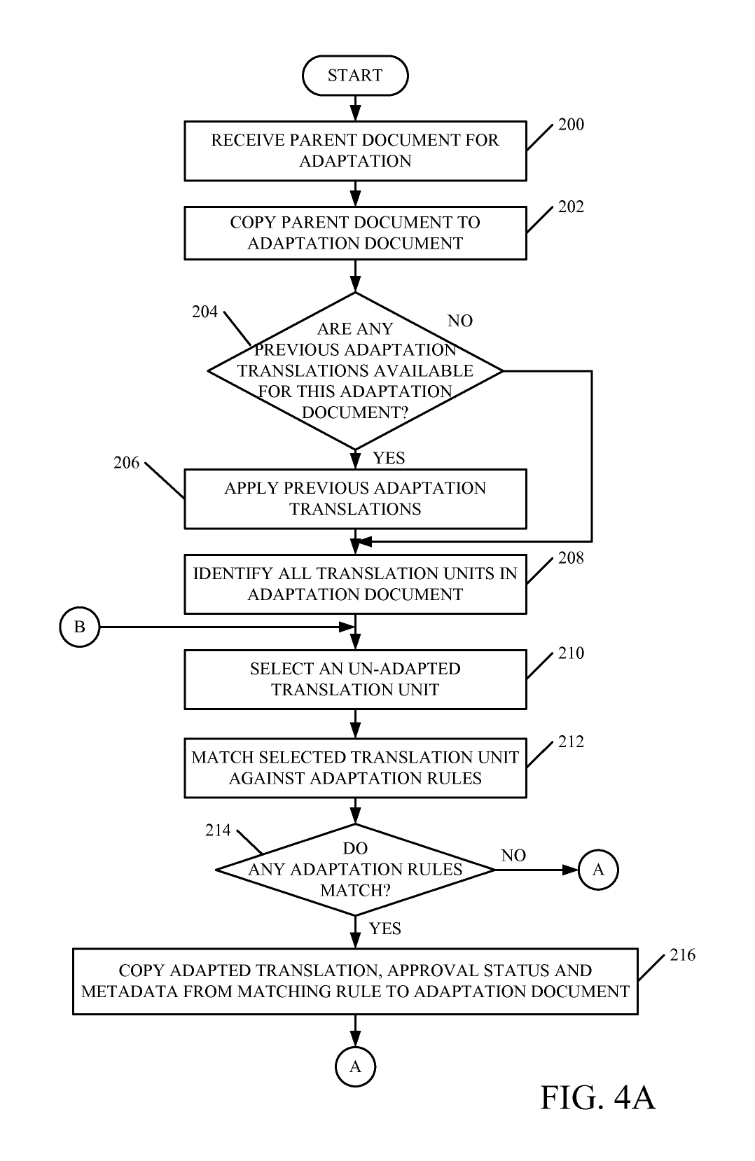

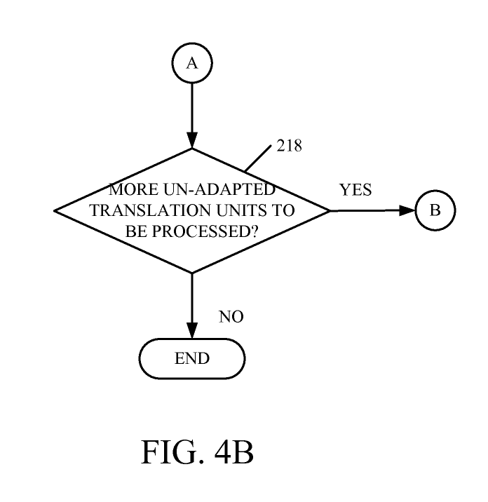

Once a set of adaptation rules 112 have been generated by user 126 in system 100, they can be applied by adaptation engine 104 in executing the rule-based adaptation translation process on parent language document 122. FIGS. 4A and 4B (collectively referred to as FIG. 4) show a flow diagram illustrating one embodiment of the operation of system 100 in executing such a rules-based process.

System 100 first receives the parent language document 122 (or parent document 122). The parent document 122 may be a given document or resource file where the parent language translations have, illustratively, been finalized and validated. Receiving the parent document for adaptation is indicated by block 200 in FIG. 4. Engine 104 then copies the parent language document 122 into an adaptation document, upon which the adaptation process will be run. This is indicated by block 202 in FIG. 4.

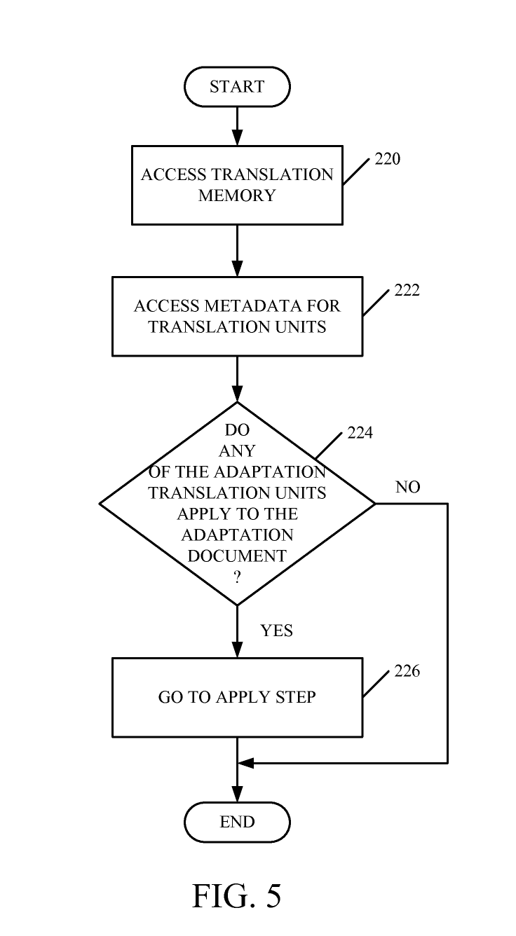

Adaptation engine 104 then determines whether there are any previous adaptation translations available in data store 108 for this adaptation document. This is indicated by block 204 in FIG. 4. For instance, in a previously released document or resource file, an adaptation translation may have already been completed. In that case, where the parent document 122 is the same as in the previous release, no further adaptations need to be performed and the previous adaption translations can simply be copied. Of course, individual translation units in the parent document 122 may also have previous translation adaptations which can be applied as well. In any case, adaptation engine 104 retrieves and applies previous adaptation translations that are applicable to the present parent document, and this is indicated by block 206 in FIG. 4. Identifying and applying previous adaptation translations is described in greater detail below with respect to FIG. 5.

Adaptation engine 104 then analyzes the adaptation document to identify all translation units in the adaptation document. This is indicated by block 208 in FIG. 4. Adaptation engine 104 then selects one of the un-adapted translation units identified at block 208, for further processing. This is indicated by block 210 in FIG. 4.

Adaption engine 104 then matches the selected translation unit against the adaptation rules 112 in data store 110. This is indicated by block 212 in FIG. 4. In one illustrative embodiment, the globally scoped adaptation rules are matched last. Therefore, if any adaptation rule 112 (other than a global scope adaptation rule) matches the selected translation unit based upon the scope defined in the rule, the corresponding adaptation translation (see Table 1 above) is copied from the adaptation rule that has been matched to the adaptation document, and the adaptation translation status flag (which shows the adaptation translation approval status) is set to “approved”. Other additional details can be added about the adaptation rule 112 that has been applied to generate this adapted translation. Matching the selected translation unit against the adaptation rules and copying the adapted translation and approval status (and possibly other metadata) from the matching rule to the adaptation document is indicated by blocks 214 and 216 in FIG. 4.

If a globally scoped adaptation rule is found to match the selected translation unit, then the source term for the translation unit is tokenized by word and matched against the globally scoped adaptation rule for matching against the adapted term in the globally scoped adaptation rule. If a match is found, then the adapted translation in the matched rule replaces the corresponding adapted translation in the adaptation document, but the adaptation translation approval status flag is set for “further review”, instead of “approved”. Adaptation engine 104 then determines whether there are any more un-adapted translation units to be processed in the adaption document. If so, processing reverts back to block 210 where a next un-adapted translation unit is selected. If so, the process is completed. This is indicated by block 218 in FIG. 4.

FIG. 5 is a flow diagram illustrating how previous adaptation translations can be applied to an adaptation document (as was indicated by block 206 in FIG. 4) in more detail. In one embodiment, adaptation engine 104 first accesses prior business adaptation translation data store (or memory) 108. This is indicated by block 220 in FIG. 5. Adaptation engine 104 then accesses the metadata for the translation units stored in data store 108. This is indicated by block 222. Engine 104 then determines whether any of the adaptation translation units in data store 108 applies to the adaptation document. This is indicated by block 224 in FIG. 5. If not, processing simply proceeds with respect to block 208 in FIG. 4. However, if they do apply, then processing proceeds to the “apply” step 206 in FIG. 4, which propagates the prior adapted translations and the associated metadata into the adaptation document. This is indicated by block 226 in FIG. 5.

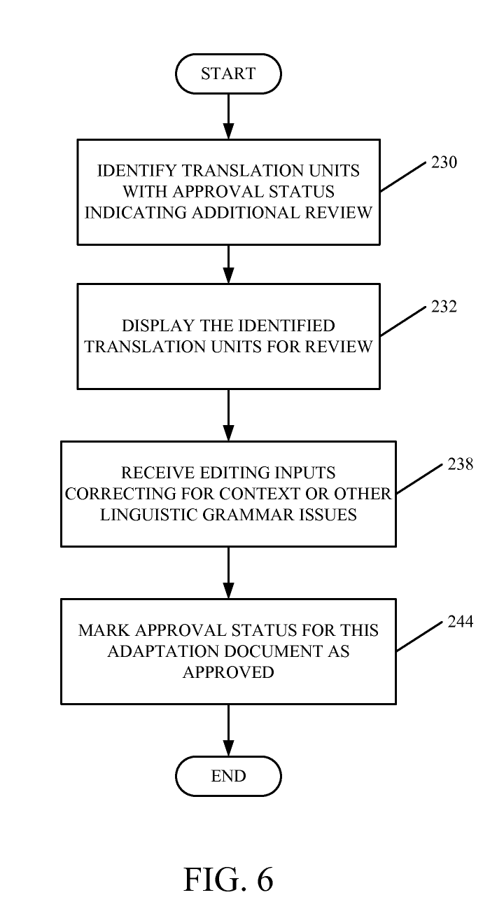

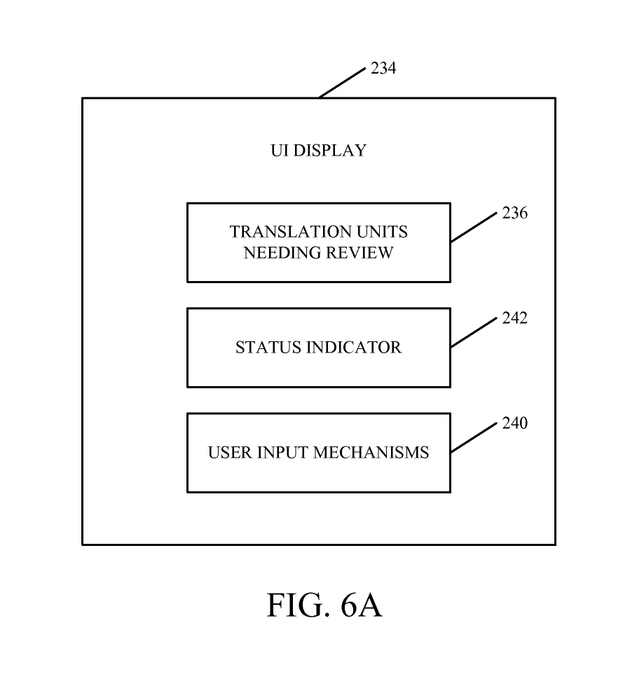

FIG. 6 is a flow diagram illustrating one embodiment of the operation of system 100 (shown in FIG. 1) in generating the document for review by user 126. First, adaptation engine 104 illustratively identifies all translation units in the adaptation document that have an approval status indicating that additional review is to be performed. This is indicated by block 230 in FIG. 6.

Adaptation engine 104 then uses user interface component 114 to generate a suitable user interface display 125 for displaying the identified translation units for review by user 126. This is indicated by block 232 in FIG. 6. FIG. 6A shows one exemplary user interface display 234 that is used to display translation units needing additional review on a suitable user interface mechanism 236, to user 126. User 126 can then provide editing inputs correcting the translation unit for context or other linguistic grammar issues. Receiving the editing inputs is indicated by block 238 in FIG. 6A. In one embodiment, the editing inputs can be provided through a suitable user input mechanism 240 shown in FIG. 6A.

Once the user 126 has approved the translation unit, user 126 can modify the status indicator through a suitable user input mechanism 242 to mark the approval status for this adaptation document as “approved”. This is indicated by block 244 in FIG. 6.

Note that in displaying the translation unit on user interface mechanism 236, adaptation engine 234 can also output the parent language translation and the adapted translation for review by user 126 as well. This may assist in reviewing the translation unit.

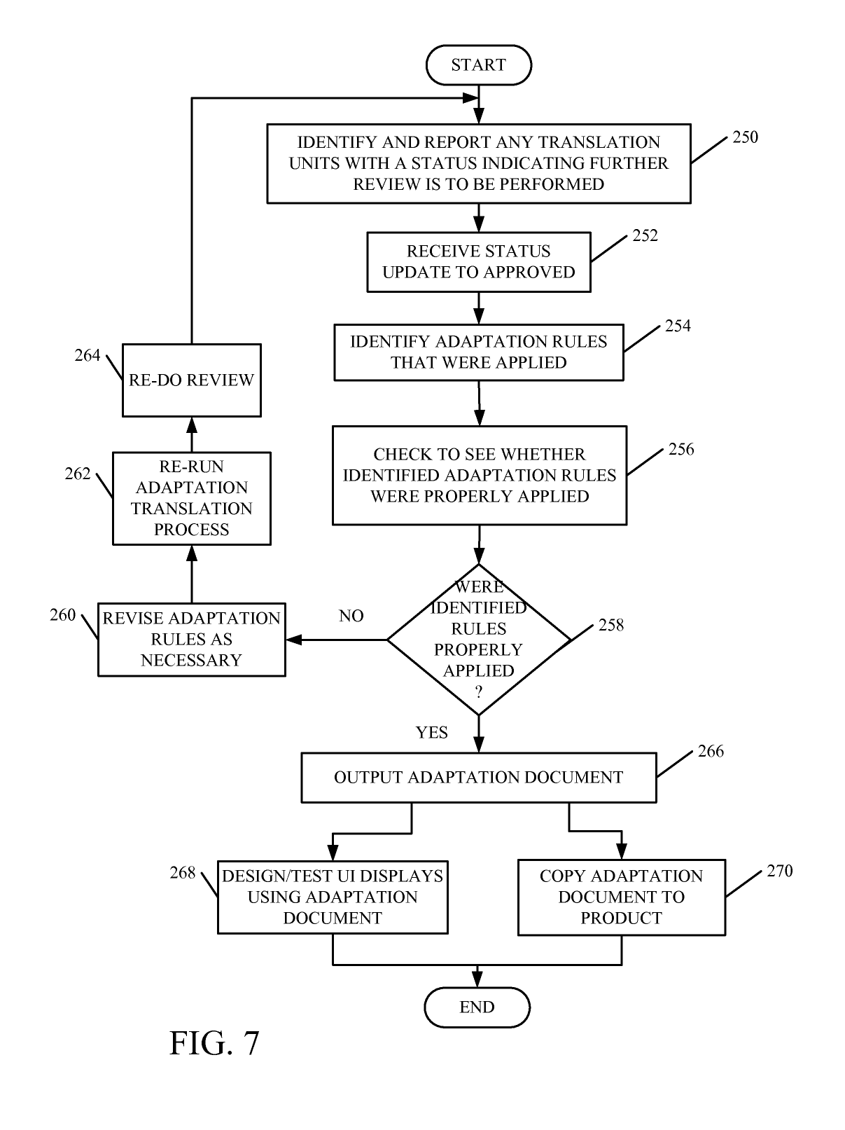

After the adaptation document has been sufficiently reviewed and approved, rule validation component 106 illustratively validates that the adaptation rules 112 have been accurately applied. FIG. 7 is a flow diagram illustrating one embodiment of the operation of rule validation component 106 in performing this validation, in more detail.

Validation component 106 first identifies and reports any translation units in the document that still have a status indicating that further review is to be performed. These are displayed to user 126 so the user can take further action and mark them as “approved”. This is indicated by blocks 250 and 252 in FIG. 7. Rule validation component 106 then identifies any of the adaptation rules 112 that have been applied in the adaptation document. This is indicated by block 254.

Rule validation component 106 then checks to see whether the identified adaptation rules have been applied properly. This is indicated by block 256. For instance, where a rule has an exclusion, validation component 106 ensures that the rule has not been applied under the excluded circumstances. That is, validation component 106 ensures that the rule has not been over-applied where it should have been excluded. Further, given the context of the translation unit, rule validation component 106 ensures that no more exclusions should be added to a given adaptation rule. Determining whether the identified adaptation rules have been properly applied can include other processing as well and is indicated by block 258 in FIG. 7.

If the rules need revision, then adaptation component 106 generates a suitable user interface 125 that allows user 126 to revise the adaption rules 112, as necessary. This is indicated by block 260 in FIG. 7.

If any of the adaptation rules 112 have been revised, then adaption engine 104 re-runs the adaptation translation process on the adaptation document, to make sure that the adaptation rules 112 are properly applied. This is indicated by block 262 in FIG. 7. Adaptation engine 104 then again allows user 126 to review the adaptation document as indicated by block 264, and processing reverts back to block 250 where rule validation component 106 again begins to validate that the adaptation rules have been properly applied.

If, at block 258, it is determined by rule validation component 106 that the adaptation rules have been properly applied, then adaption document 124 (or adapted language document 124) is output as indicated by block 266 in FIG. 7. Document 124 can then be used to either design or test user interface displays as indicated by block 268, or it can simply be copied into a business product 118. This is indicated by block 270 in FIG. 7.

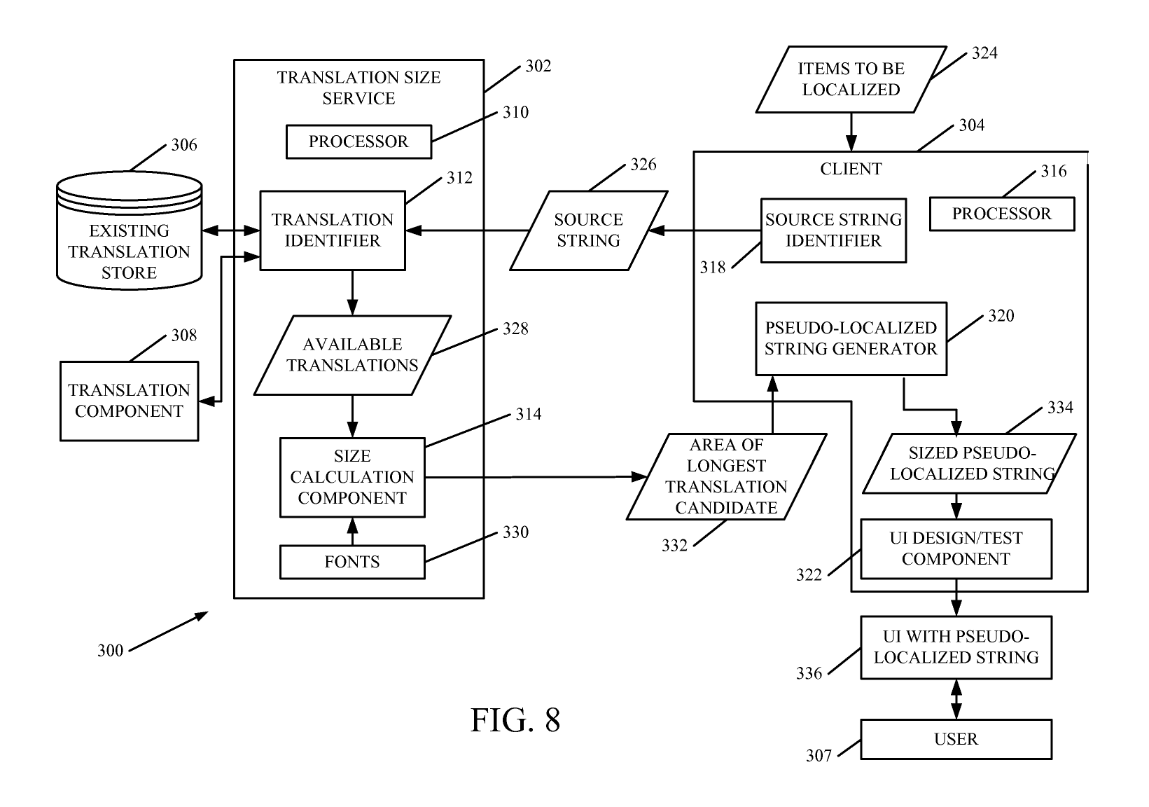

FIG. 8 is a block diagram showing a user interface generation or test system 300. In the architecture shown in FIG. 8, system 300 includes a translation size service 302 and a client 304. Client 304 is being used by a user 306 to generate or test the design of user interfaces on a given product. FIG. 8 also shows that system 300 has access to an existing translation store 306 and a translation component 308. Of course, existing translation store 306 and translation component 308 can be part of service 302 or remote therefrom. In addition, the client/service architecture is only one exemplary architecture and parts of both the client and service can be combined or further divided and employed in different architectures.

In the embodiment shown in FIG. 8, translation size service 302 includes processor 310, translation identifier 312, and size calculation component 314. Client 304 illustratively includes processor 316, source string identifier 318, pseudo-localized string generator 320, and user interface (UI) design/test component 322.

It should be noted that data store 306 and component 308 can be part of service 302 or separate therefrom. In addition, in one embodiment, processors 310 and 316 are computer processors with associated memory and timing circuitry (not shown). Processors 310 and 316 form functional components of service 302 and client 304, respectively, and facilitate the functionality of the other components, or generators or other items in service 302 and client 304, respectively.

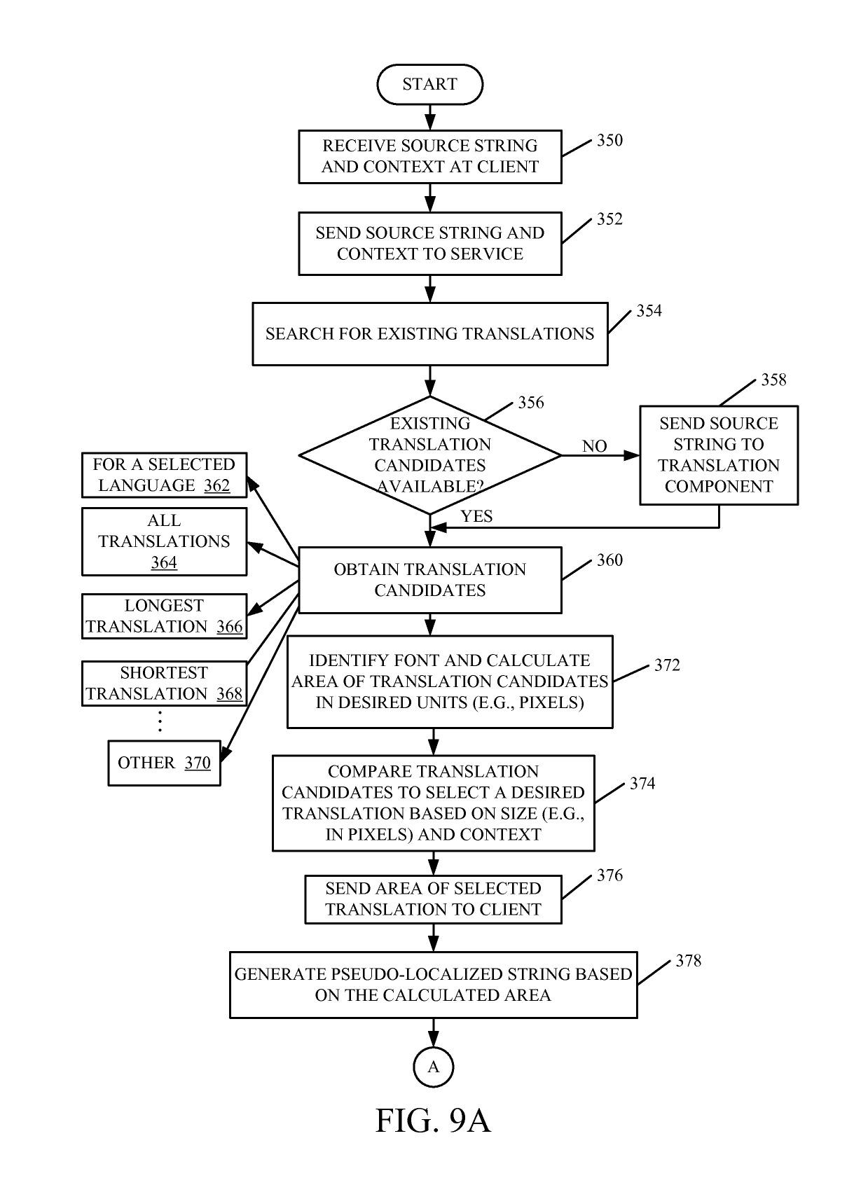

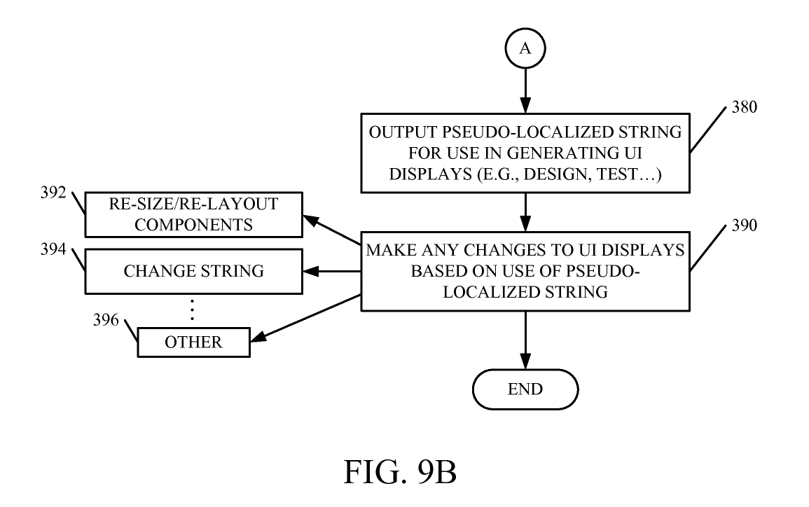

While the detailed operation of system 300 is discussed below with respect to FIG. 9, it will be discussed briefly here for the sake of overview. In general, client 304 illustratively receives an item to be localized 324. The item can be, for instance, a string from a resource file, or any other item. Client 304 then sends a source string 326, from item 324, to translation size service 302. Service 302 then identifies whether there are any existing translations of source string 326 in store 306. If not, service 302 provides source string 326 to translation component 308, which translates it. The available translation candidates 328 are then provided to size calculation component 314 which calculates the size in square units (such as in units of square pixels) of the available translations candidates 328, based upon the particular font 330 that is used in the target language. Service 302 then provides the area 332, of a selected translation candidate, back to client 304. Pseudo-localized string generator 320 generates pseudo-localized string 334 that has approximately the same size as the area 332 sent by service 302. The pseudo-localized string 334 can be used by UI design/test component 322 in order to generate or test a user interface display with the pseudo-localized string as indicated by block 336.

FIGS. 9A and 9B (collectively FIG. 9) illustrate a flow diagram showing the overall operation of system 300 in more detail. Client 304 first receives a source string, and the context for the source string. In one embodiment, the source string 326, along with its context, is identified by source string identifier 318 in the item to be localized 324. In one embodiment, source string identifier 318 breaks the item to be localized 324 into one or more different source strings. A selected one of the source strings 326 (along with its context) is then provided by client 304 to translation size service 302. Receiving the source string (along with its context) and sending the source string and the context to service 302 is indicated by blocks 350 and 352 in FIG. 9, respectively.

Translation identifier 312 then searches existing translation store 306 for existing translations, in one or more target languages, of source string 326. This is indicated by block 354 in FIG. 9. Translation identifier 312 identifies all possible candidate translations that already exist in data store 306.

If there are no existing translations in store 306 (or optionally even if there are existing translations) translation identifier 312 sends source string 326 to translation component 308 to have it translated. Determining whether there are any existing translations and sending source string 326 to translation component 308 are indicated by blocks 356 and 358, respectively, in FIG. 9. Translation component 308 can be a machine translation component, such as a statistical or rules-based translation component. Of course, it can include natural language processing capabilities and other translation functionality as well. In any case, translation identifier 312 obtains one or more available translation candidates 328. This is indicated by block 360 in FIG. 9.

It should be noted in obtaining available translation candidates 328, translation identifier 312 can use a variety of different approaches. These can be configurable by user 307, or otherwise. For instance, translation identifier 312 may identify all translation candidates for a selected language. This is indicated by block 362 in FIG. 9. Alternatively, or in addition, translation identifier 312 can obtain all translations for all languages for source string 326. This is indicated by block 364 in FIG. 9. Of course, translation identifier 312 can obtain other translations as well, such as only the longest translation, regardless of language. This is indicated by block 366. Translation identifier 312 could, of course, obtain the shortest translation as indicated by block 368, or any other translation candidates, or a subset of them, as indicated by block 370.

Size calculation component 314 then calculates the size of each of the available translation candidates 328 provided to it by translation identifier 312. This can be done using a variety of different units. In one embodiment, component 314 calculates the area of available translation candidates 328 in terms of square pixels. In one embodiment, the area is calculated in some type of user interface display unit. This can be a unit of measure (such as square inches, square centimeters, etc.) or it can be in another type of display unit such as in square pixels. This is indicated by block 372 in FIG. 2. In calculating the area, size calculation component 314 considers the particular font 330 that is used with each available translation candidate 328. For instance, some computer systems use different fonts, depending on the particular language being used. Size calculation component 314 considers the size of those fonts 330 in calculating the area of each of the available translation candidates 328.

Translation identifier 312 then compares the various translation candidates to identify a desired translation based on size and based on context. In one embodiment, translation identifier 312 recognizes the nature of the product which is being designed, and the nature or context of source string 326 in order to choose a particular translation based on its size. For example, translations from mobile applications tend to be shorter than those from desktop applications due to the limited display space available on a mobile device. Also, translations of menu names tend to be shorter than those of error messages, due to the purpose of the source string. In one embodiment, translation identifier 312 not only considers the purpose and nature of the device and source string and product, but includes other context items for source string 326 as well. Translation identifier 312 uses this context information to weight the available translation candidates 328 and then chooses one of the available translation candidates based on that weight and based on the size (e.g., in square pixels) of the available translation candidates 328. This is indicated by block 374 in FIG. 9.

Once translation identifier 312 has identified the desired translation candidate, size calculation component 314 sends the area of the selected translation to client 304. As one example, translation identifier 312 identifies the longest translation and therefore size calculation component 314 sends the area of the longest translation candidate 332 to client 304. Of course, no matter what the selected translation is, size calculation component 314 sends the area of the selected translation to client 304. This is indicated by block 376 in FIG. 9.

Pseudo-localized string generator 320 then generates pseudo-localized string 334 that has approximately the same size as the area 332 received from service 302. There are a variety of different ways for generating a pseudo-localized string. For example, pseudo-localized string generator 320 can assemble random characters as a pseudo-localized string, so long as they have the same area as received from service 302. Of course, generator 320 can use non-random or pseudo-random characters as well or any other set or combination of characters, including the selected translation itself. In any case, generating the pseudo-localized string based on the calculated area 332 is indicated by block 378 in FIG. 9.

Generator 320 then outputs the pseudo-localized string 334 to UI design/test component 322 where it can be used for generating user interface displays, for localizing already-generated user interface displays to a localized product, for testing user interface displays to identify truncation errors, word wrap errors, or other types of errors, etc. Outputting the pseudo-localized string for use in generating or testing UI displays is indicated by block 380 in FIG. 9.

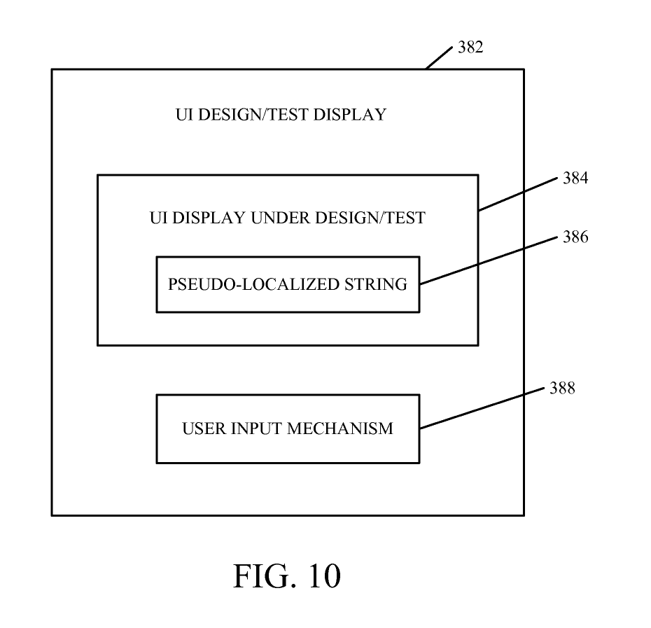

In one embodiment, UI design/test component 322 provides the UI with the pseudo-localized string on a user interface display 336 to user 307. FIG. 10 shows one embodiment of a user interface display 382 that can be used. It can be seen that UI design/test display 382 includes a display of the particular user interface display or user interface screen that is currently being designed or tested. This is indicated by block 384 in FIG. 10. The UI display 384 illustratively includes the pseudo-localized string in a user interface display element (such as a text box or other user interface display element) 386. Display 382 also illustratively provides user input mechanisms 388 that allow user 307 to make modifications to the UI display 384 that is currently being designed or tested, in order to accommodate the size of the pseudo-localized string in display element 386. Making changes to the UI display based on the use of the pseudo-localized string is indicated by block 390 in FIG. 9. Of course, these changes can be a wide variety of different changes. For instance, user 307 may re-size or re-layout user interface components (such as display item 386) based on the pseudo-localized string. This is indicated by block 392. User 307 may change the string to make it larger or smaller. This is indicated by block 394. Of course, user 307 can make other changes as well, as indicated by block 396.

It can thus be seen that system 300 sizes the pseudo-localized string based on actual existing translations or machine translations. It calculates the screen real-estate that will be occupied by a given string, in square units (such as in square pixels or other units). Further, it is context sensitive to narrow down the translations that might be used to generate the size of the pseudo-localized string. This can be done based on the domain of the source string, the device for which the product is being designed, the device that the source string came from, the particular nature of the source string, or other contextual information. In addition, the system dynamically considers the particular font and style of the eventual string to be generated, in obtaining a size for the pseudo-localized string. This enhances UI design when a new operating system or application is provided on multiple devices or introduces a new font among languages which has a different glyph from the ordinal fonts, yet it does not require changing UI strings or significant re-design.

FIG. 7 is a block diagram of systems 100 and 300, shown in various architectures, including cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of systems 100 and 300 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

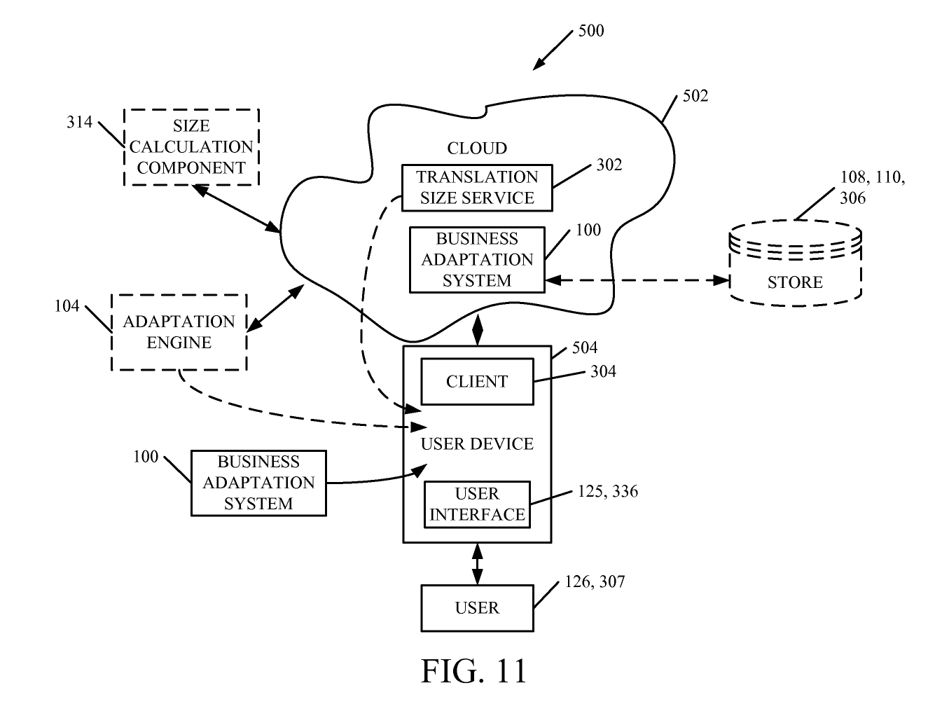

The embodiment shown in FIG. 11 specifically shows that all or portions of systems 100 and 300 can be located in cloud 502 (which can be public, private, or a combination where portions are public while others are private). Therefore, user 126, 307 uses a user device 504 to access those systems through cloud 502.

FIG. 11 also depicts another embodiment of a cloud architecture. FIG. 11 shows that it is also contemplated that some elements of systems 100 and 300 are disposed in cloud 502 while others are not. By way of example, data stores 108, 110, 306 can be disposed outside of cloud 502, and accessed through cloud 502. In another embodiment, some or all of the components of systems 100 and 300 are also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. FIG. 11 further shows that some or all of the portions of systems 100 and 300 can be located on device 504. All of these architectures are contemplated herein.

It will also be noted that systems 100 and 300, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

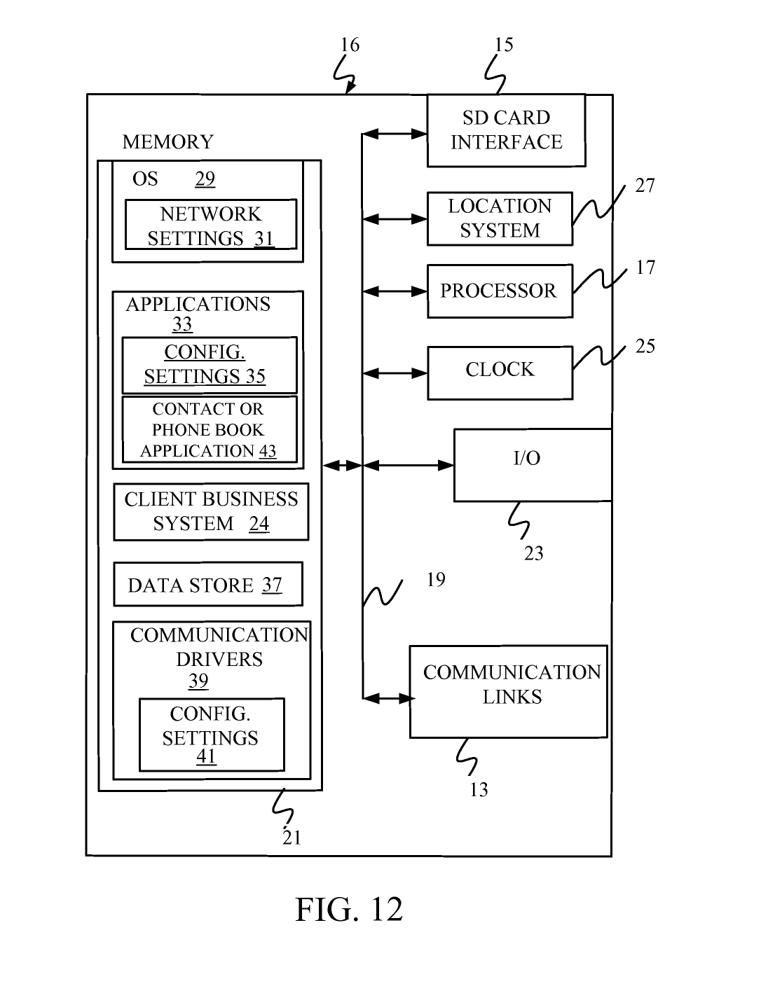

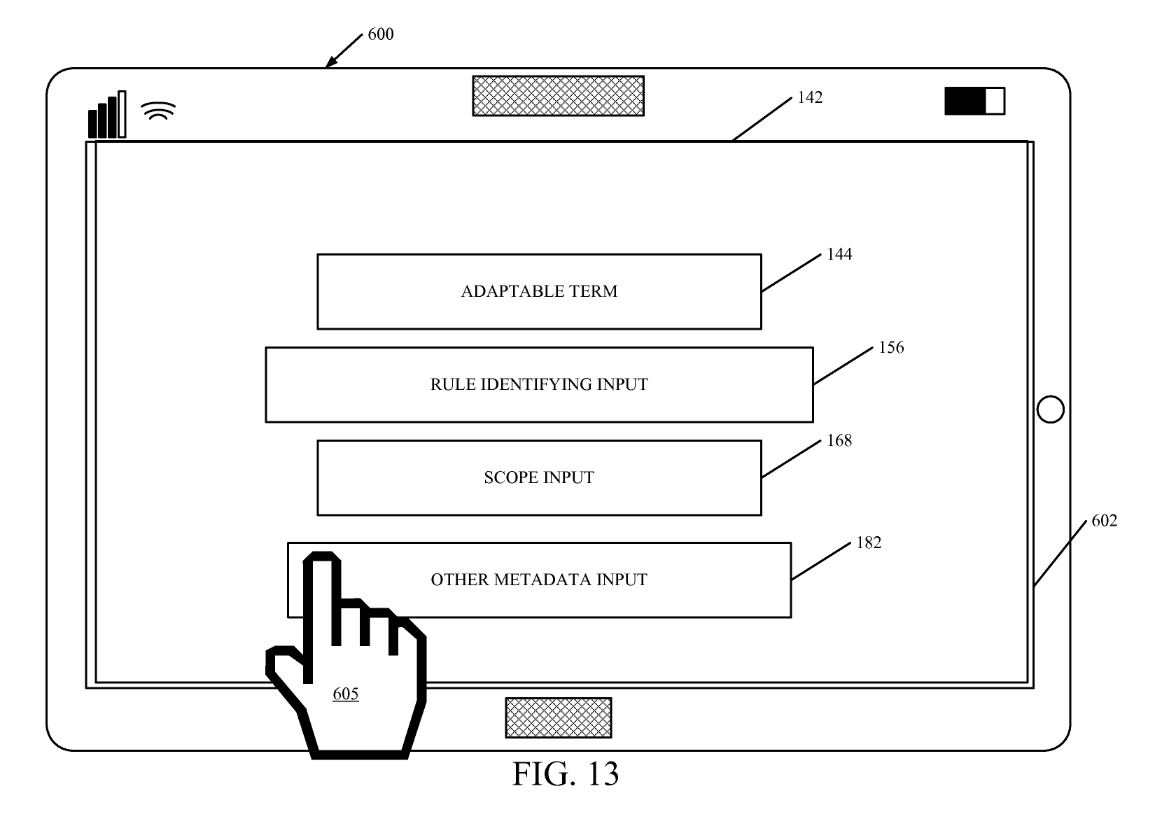

FIG. 12 is a simplified block diagram of one illustrative embodiment of a handheld or mobile computing device that can be used as a user's or client's hand held device 16, in which the present systems (or parts of them) can be deployed. FIGS. 13-16 are examples of handheld or mobile devices.

FIG. 12 provides a general block diagram of the components of a client device 16 that can run components of system 100 or system 300 or that interacts with systems 100 or 300, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100 or system 300) are received on a removable Secure Digital (SD) card that is connected to a SD card interface 15. SD card interface 15 and communication links 13 communicate with a processor 17 (which can also embody processor 100 from FIG. 1 or processors 310 and 316 from FIG. 8) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Systems 100 or 300 or the items in data stores 108, 110, 306, for example, can reside in memory 21. Similarly, device 16 can have a client business system 24 which can run various business applications or embody parts or all of system 100 or system 300 or both. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

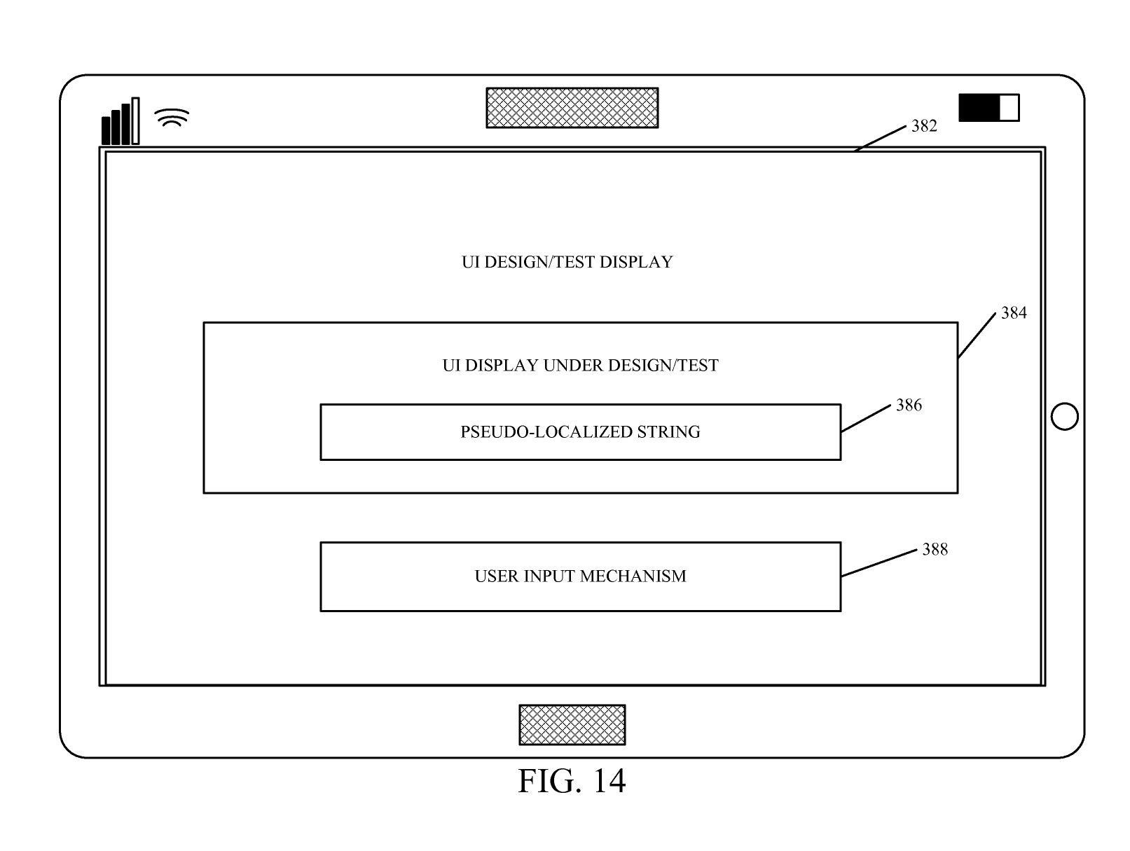

FIGS. 13 and 14 show one embodiment in which device 16 is a tablet computer 600. In FIG. 13, computer 600 is shown with display screen 602 with the user interface display of FIG. 3A displayed thereon. FIG. 14 shows computer 600 with the user interface display of FIG. 10 displayed thereon. Screen 602 can be a touch screen (so touch gestures from a user's finger 605 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

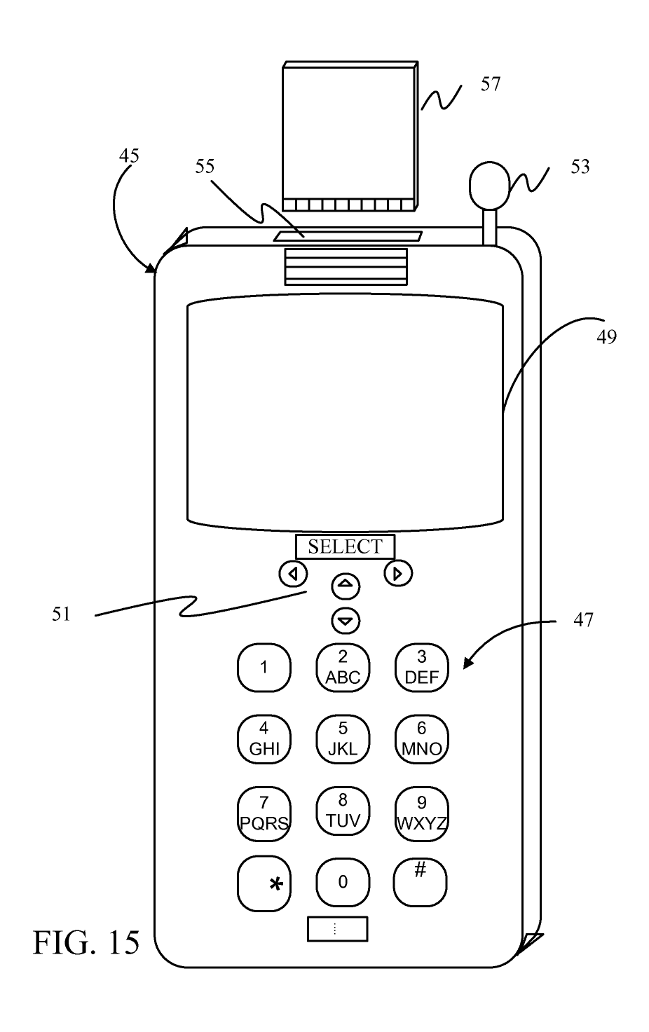

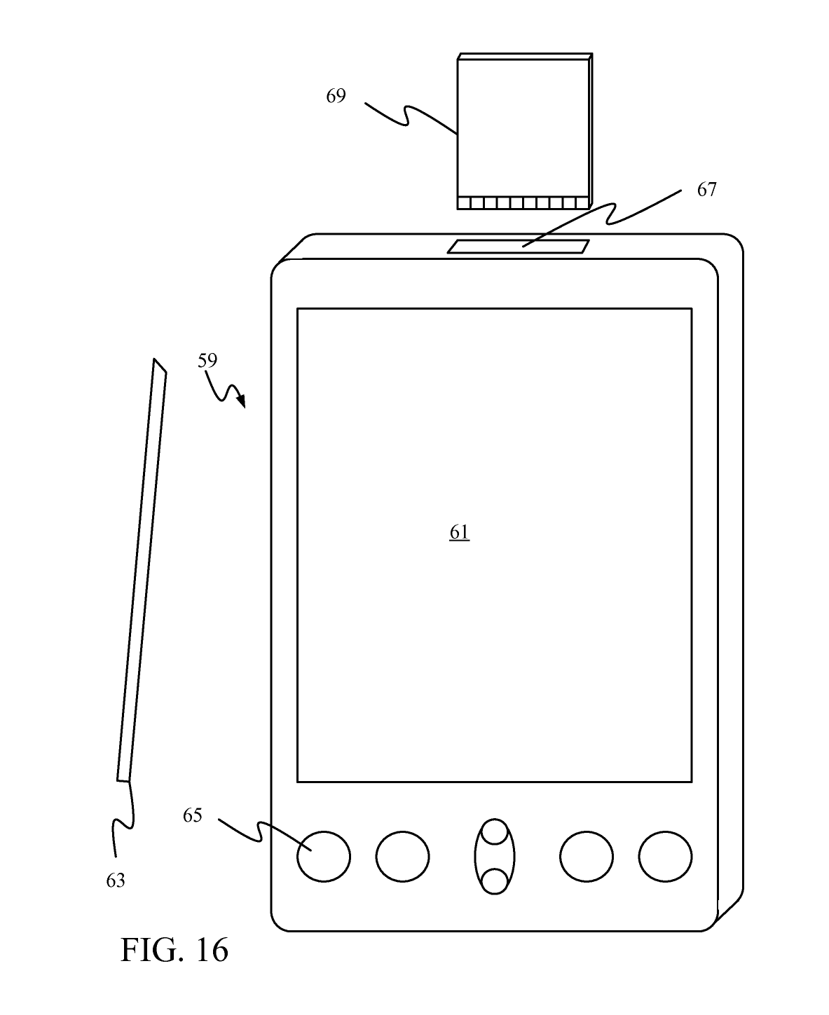

FIGS. 15 and 16 provide additional examples of devices 16 that can be used, although others can be used as well. In FIG. 15, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals. In some embodiments, phone 45 also includes a Secure Digital (SD) card slot 55 that accepts a SD card 57.

The mobile device of FIG. 16 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

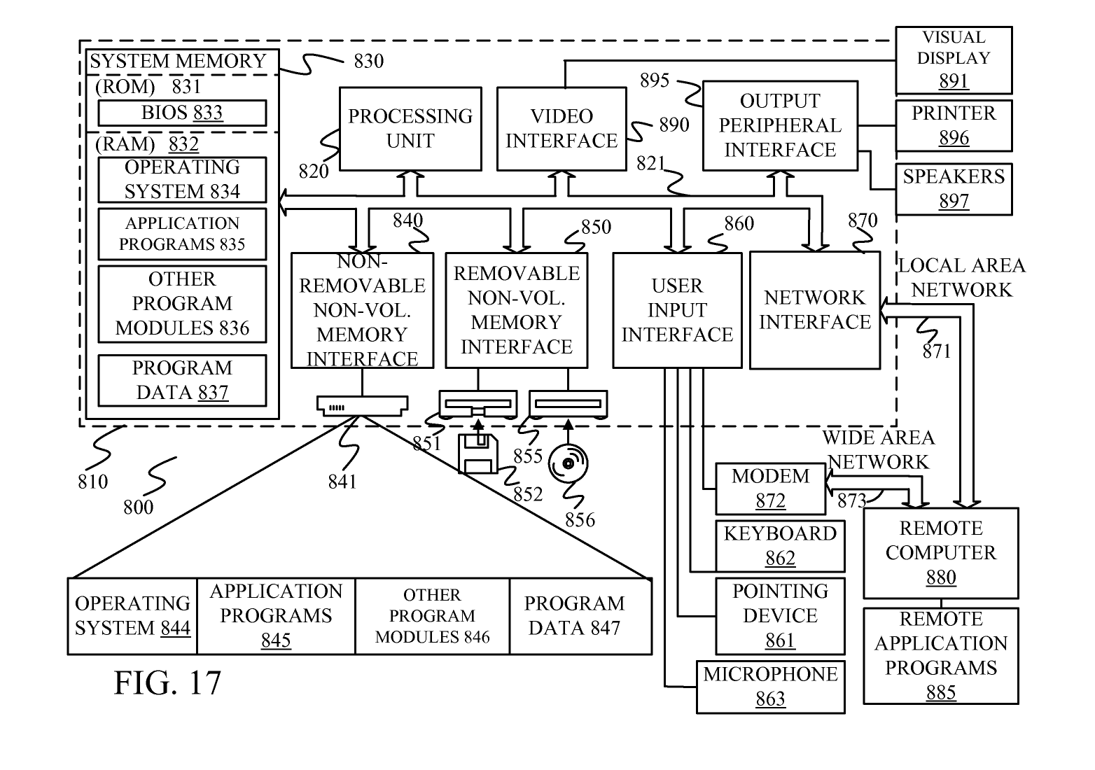

FIG. 17 is one embodiment of a computing environment in which system 100 or system 300 (for example) can be deployed. With reference to FIG. 17, an exemplary system for implementing some embodiments includes a general-purpose computing device in the form of a computer 810. Components of computer 810 may include, but are not limited to, a processing unit 820 (which can comprise processor 102, 310 or 316), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIGS. 1-10 can be deployed in corresponding portions of FIG. 17.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 17 illustrates operating system 834, application programs 835, other program modules 836, and program data 837.

The computer 810 may also include other removable/non-removable volatile/nonvolatile computer storage media. By way of example only, FIG. 17 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 17, provide storage of computer readable instructions, data structures, program modules and other data for the computer 810. In FIG. 17, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 17 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 17 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method of adapting a parent document in a parent language to an adapted document in a variant language that is a variant of the parent language, comprising:
receiving the parent document;
executing a computer-implemented, rule-driven adaptation process to obtain the adapted document; and
displaying the adapted document in the variant of the parent language.

2. The computer-implemented method of claim 1 wherein executing the computer-implemented, rule-driven adaptation process, comprises:
identifying an un-adapted translation unit in the parent document;
matching the identified un-adapted translation unit against a plurality of adaptation rules to identify a matching adaptation rule; and
copying an adapted unit from the matching adaptation rule into the parent document, for the identified un-adapted translation unit.

3. The computer-implemented method of claim 2 wherein executing the computer-implemented, rule-driven adaptation process, comprises:
determining whether the matching adaptation rule is to be reviewed;
if so, setting a review status indicator; and
displaying the adapted unit in the adapted document with a visual indicator indicating it is to be reviewed.

4. The computer-implemented method of claim 3 wherein executing the computer-implemented, rule-driven adaptation process, comprises:
receiving any editing inputs to edit the adapted unit; and
receiving a reset input resetting the review status indicator to indicate that no further review is needed.

5. The computer-implemented method of claim 2 and further comprising:
displaying a rules input user interface display; and
receiving the adaptation rules through the rules input user interface display.

6. The computer-implemented method of claim 5 wherein receiving the adaptation rules comprises:
receiving a scope input corresponding to each given adaptation rule, the scope input indicating a scope of application of each given adaptation rule to un-adapted translation units in the parent document.

7. The computer-implemented method of claim 6 wherein executing the computer-implemented, rule-driven adaptation process, comprises:
after copying the adapted unit from the matching adaptation rule, validating that the matching adaptation rule was applied with a scope indicated by the scope of application corresponding to the matching adaptation rule.

8. The computer-implemented method of claim 2 wherein executing the computer-implemented, rule-driven adaptation process, comprises:
before matching the identified un-adapted translation unit against a plurality of adaptation rules, accessing an adaptation translation store to determine whether the identified un-adapted translation unit has already been adapted to the variant language and stored in the adaptation translation store; and
if so, copying the adapted unit from the adaptation translation store into the parent document, for the identified un-adapted translation unit.

9. The computer-implemented method of claim 2 and further comprising:
calculating a size, in display units, of the adapted unit; and
sending the size to a pseudo-localized string generator for generation of a pseudo-localized string for verifying design of a user interface display.

10. The computer-implemented method of claim 9 wherein calculating a size comprises:
identifying a font used for the variant language; and
calculating an area of the adapted unit based on the identified font.

11. A computer-implemented method of generating a user interface display element, comprising:
sending a source string in a source language to a translation size service;
receiving, from the translation size service, a size indicator indicating a size, in display units, of a translation candidate, the translation candidate being a translation of the source string into a target string in a target language;
generating a string with a display size corresponding to the size indicator; and
generating the user interface display element with an element size based on the generated string.

12. The computer-implemented method of claim 11 wherein generating a string comprises:
generating a pseudo-localized string with characters sized so the display size of the pseudo-localized string conforms to the size indicated by the size indicator.

13. The computer-implemented method of claim 12 wherein generating the user interface display element comprises:
generating an element that displays text with a size that accommodates display of the pseudo-localized string.

14. The computer-implemented method of claim 11 wherein generating a user interface display element comprises:
designing a textual display element, or text to be displayed, on a user interface display.

14. The computer-implemented method of claim 11 wherein generating a user interface display element comprises:
testing a textual display element on a user interface display.

15. A computer-implemented method, comprising:
receiving a source string in a source language, from a client;
obtaining a translation of the source string into a target string in a target language;
calculating a size of the target string, in display units; and
sending the size of the target string to the client.

16. The computer-implemented method of claim 15 wherein receiving the source string comprises:
receiving a context of the source string.

17. The computer-implemented method of claim 15 wherein obtaining a translation comprises:
obtaining a set of translation candidates for the source string.

18. The computer-implemented method of claim 17 wherein 17 wherein calculating a size comprises:
identifying a font based on the target language;
calculating an area, in display units, corresponding to each of the translation candidates in the set based on the identified font; and
comparing the translation candidates based on the corresponding area and context, to select a given translation candidate, wherein the size comprises the area corresponding to the given translation candidate.

19. The computer-implemented method of claim 18 wherein the given translation candidate is chosen as the translation candidate having the largest corresponding area.

20. The computer-implemented method of claim 17 wherein obtaining the set of translation candidates comprises:
obtaining the set of translation candidates from an existing translation store.
